(19) United States
(12) Patent Application Publication
(10) Pub. No.: US 2020/0081436 A1
(43) Pub. Date: Mar. 12, 2020

(54) POLICY GENERATION DEVICE AND VEHICLE

(71) Applicant: HONDA MOTOR CO., LTD., Tokyo (JP)

(72) Inventor: Yuki KIZUMI, Wako-shi (JP)

(21) Appl. No.: 16/680,919

(22) Filed: Nov. 12, 2019

Related U.S. Application Data
(63) Continuation of application No. PCT/JP2017/020643, filed on Jun. 2, 2017.

(51) Int. Cl. G05D 1/00; G06N 20/00

(52) U.S. Cl. CPC G05D 1/0088; G05D 2201/0213; G06N 20/00

(57) ABSTRACT

A device for generating a policy for determining a path in automated driving of a vehicle, comprises a compensation estimator; and a processing unit for generating a policy so as to increase an expected value of compensation obtained by inputting a situation surrounding a vehicle and an action of the vehicle to the estimator. The processing unit generates an intermediate policy through reinforcement, determines an action that a vehicle is to take by applying the intermediate policy to an actual surrounding situation of a driver, determines whether an error between the determined action and an actual action by the driver is smaller than or equal to a threshold. If the error is larger than the threshold, compensation of the estimator is updated and the intermediate policy is determined again. Otherwise, the intermediate policy is set as the policy.

### CROSS-REFERENCE TO RELATED APPLICATION

This application is a continuation of International Patent Application No. PCT/JP2017/020643 filed on Jun. 2, 2017, the entire disclosure of which is incorporated herein by reference.

### TECHNICAL FIELD

The present invention relates to a policy generation device and a vehicle.

### BACKGROUND ART

Artificial intelligence-related technologies have been applied to driving assistance and automated driving. Patent Literature 1 describes a technology for extracting a high-risk object from a location pattern of the object using a neural network that is based on a visual attention model of a skilled driver.

### CITATION LIST

### Patent Literature

PTL1: Japanese Patent Laid-Open No. 2008-230296

### SUMMARY OF INVENTION

### Technical Problem

In Patent Literature 1, an extracted high-risk target object is simply presented to a driver and is not used in vehicle travel control. It is possible to define actions that are to be inhibited in automated driving (e.g. approach to such an object), using the high-risk target object. However, it is difficult to simulate natural traveling that is performed by a human driver, especially a skilled driver, only by avoiding the actions that are to be inhibited. Some aspects of the present invention aim to provide a technology for generating a policy for simulating traveling that is performed by a human driver.

### Solution to Problem

According to an embodiment, a device for generating a policy for determining a path in automated driving of a vehicle is provided, the device including: a compensation estimator; and a processing unit configured to generate a policy so as to increase an expected value of compensation obtained by inputting a situation surrounding a vehicle and an action of the vehicle to the compensation estimator, wherein the processing unit is configured to: generate an intermediate policy through reinforcement learning, the reinforcement learning including: determining an action that a vehicle is to take by applying a provisional policy to a surrounding situation; obtaining an expected value of compensation by inputting the surrounding situation and the action to the compensation estimator; and updating the provisional policy until the expected value of compensation exceeds a predetermined threshold; determine an action that a vehicle is to take by applying the intermediate policy to an actual surrounding situation of a predetermined driver; determine whether an error between the action determined by applying the intermediate policy and an actual action by the predetermined driver is smaller than or equal to a threshold; if the error is larger than the threshold, update compensation of the compensation estimator and determine again the intermediate policy with the compensation estimator having the updated compensation; and if the error is smaller or equal to the threshold, set the intermediate policy as the policy.

### Advantageous Effects of Invention

According to the present invention, a technology for generating a policy for simulating traveling that is performed by a human driver is provided.

Other features and advantages of the present invention will be apparent in the following description with reference to the attached drawings. In the attached drawings, like elements are assigned like reference numerals.

### BRIEF DESCRIPTION OF DRAWINGS

The attached drawings are included in the specification and constitute a part thereof, illustrate embodiments of the present invention, and are used to explain the principle of the present invention together with the description.

FIG. 1 illustrates an example configuration of a vehicle according to some embodiments.

FIG. 2 illustrates an example configuration of a device for generating a policy according to some embodiments.

FIG. 3 illustrates an example method for generating a policy according to some embodiments.

### DESCRIPTION OF EMBODIMENTS

Embodiments of the present invention will be described below with reference to the attached drawings. Similar elements are assigned the same reference signs through various embodiments, and redundant descriptions are omitted. The embodiment may be modified or combined as appropriate.

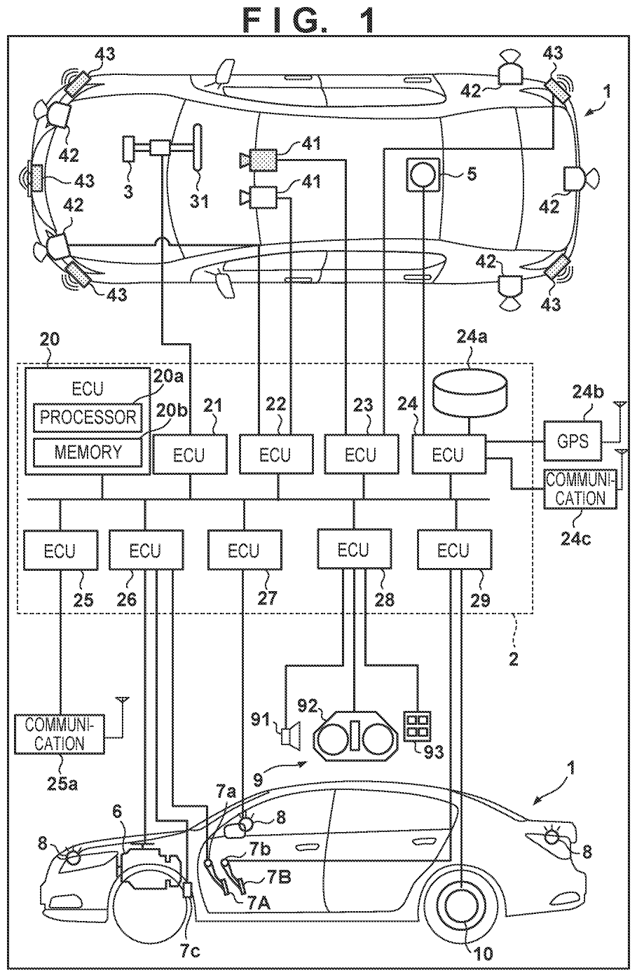

FIG. 1 is a block diagram of a vehicle control device according to an embodiment of the present invention, and the vehicle control device controls a vehicle 1. In FIG. 1, the vehicle 1 is schematically shown in a plan view and a side view. As an example, the vehicle 1 is a four-wheeled passenger car of a sedan type.

The control device in FIG. 1 includes a control unit 2. The control unit 2 includes a plurality of ECUs 20 to 29, which are communicably connected to each other through an in-vehicle network. Each of the ECUs includes a processor, which is typified by a CPU, a memory such as a semiconductor memory, an interface for an external device, and so on. Programs executed by the processor, data used in processing by the processor, and the like are stored in the memory. Each of the ECUs may include a plurality of processors, memories, interfaces, and so on. For example, the ECU 20 includes a processor 20a and a memory 20b. The processor 20a executes commands included in a program stored in the memory 20b, and thus, processing is performed by the ECU 20. Alternatively, the ECU 20 may include a dedicated integrated circuit, such as an ASIC, for the ECU 20 to perform processing.

A description will be given below of functions or the like that are dealt with by the ECUs 20 to 29. Note that the number of ECUs and functions that are dealt with thereby may be designed as appropriate, and the ECUs and the functions thereof in this embodiment may be further segmented or integrated.

The ECU 20 performs control related to automated driving of the vehicle 1. In automated driving, at least one of the steering and acceleration/deceleration of the vehicle 1 is controlled automatically. In the later-described example control, both the steering and acceleration/deceleration is controlled automatically.

The ECU 21 controls an electric power steering device 3. The electric power steering device 3 includes a mechanism for steering front wheels in accordance with a driving operation (steering operation) made to a steering wheel 31 by a driver. The electric power steering device 3 also includes a motor that exerts a driving force for assisting in the steering operation and automatically steering front wheels, a sensor for detecting a steering angle, and so on. If the driving state of the vehicle 1 is automated driving, the ECU 21 automatically controls the electric power steering device 3 in accordance with instructions from the ECU 20, and controls the direction in which the vehicle 1 proceeds.

The ECUs 22 and 23 controls detection units 41 to 43 for detecting a situation surrounding the vehicle, and performs information processing on the detection results therefrom. The detection units 41 (which may also be hereinafter referred to as cameras 41) are cameras for capturing images of an area ahead of the vehicle 1. In this embodiment, two detection units 41 are provided in a front portion of the roof of the vehicle 1. Analysis of the images captured by the cameras 41 enables extraction of an outline of an object and a marking line (a while line etc.) on a traffic lane on a road.

The detection units 42 (which may also be hereinafter referred to as lidars 42) are lidars (laser radars), which detect an object around the vehicle 1 and measure the distance to the object. In the case of this embodiment, five lidars 42 are provided, one is provided at each corner of the front part of the vehicle 1, one is provided at the center of the rear part, and one is provided on each side of the rear part. The detection units 43 (which may also be hereinafter referred to as radars 43) are millimeter wave radars, which detect an object around the vehicle 1 and measure the distance to the object. In the case of this embodiment, five radars 43 are provided, one is provided at the center of the front part of the vehicle 1, one is provided at each corner of the front part, and one is provided at each corner of the rear part.

The ECU 22 controls one of the cameras 41 and the lidars 42 and performs information processing on the detection results therefrom. The ECU 23 controls the other camera 41 and the radars 43 and performs information processing on the detection results therefrom. By providing two sets of devices for detecting a situation surrounding the vehicle, reliability of the detection results can be increased. In addition, by providing different types of detection units, namely cameras, lidars, and radars, an environment around the vehicle can be analyzed in many aspects.

The ECU 24 controls a gyro sensor 5, a GPS sensor 24b, and a communication device 24c, and performs information processing on the detection results or communication results therefrom. The gyro sensor 5 detects a rotational motion of the vehicle 1. The route of the vehicle 1 can be determined based on the detection results from the gyro sensor 5, the wheel speed, and the like. The GPS sensor 24b detects the current position of the vehicle 1. The communication device 24c wirelessly communicates with a server that provides map information and traffic information, and acquires these kinds of information. The ECU 24 can access a database 24a of map information that is constructed in the memory, and the ECU 24 searches for a route from the current location to a destination, for example. The ECU 24, the map database 24a, and the GPS sensor 24b constitute a so-called navigation device.

The ECU 25 includes a communication device 25a for inter-vehicle communication. The communication device 25a wirelessly communicates with other vehicles in a surrounding area to exchange information between the vehicles.

The ECU 26 controls a power plant 6. The power plant 6 is a mechanism that outputs a driving force for rotating driving wheels of the vehicle 1, and includes an engine and a transmission, for example. The ECU 26 controls output of the engine in accordance with a driving operation (accelerator operation or acceleration operation) performed by a driver that has been detected by an operation detection sensor 7a, which is provided in an acceleration pedal 7A, and switches the gear ratio of the transmission based on information, such as the vehicle speed, that is detected by a vehicle speed sensor 7c. If the driving state of the vehicle 1 is automated driving, the ECU 26 automatically controls the power plant 6 in accordance with instructions from the ECU 20 to control acceleration and deceleration of the vehicle 1.

The ECU 27 controls lighting devices (a head light, a tail light etc.), which includes direction indicators 8 (blinkers). In the case of the example in FIG. 1, the direction indicators 8 are provided in the front part, door mirrors, and the rear part of the vehicle 1.

The ECU 28 controls an input/output device 9. The input/output device 9 outputs information to the driver, and receives input of information from the driver. A sound output device 91 notifies the driver of information using a sound. A display device 92 notifies the driver of information through a display of an image. For example, the display device 92 is arranged in front of a driver sheet, and constitutes an instrument panel or the like. Although a sound and a display have been taken as an example here, the driver may alternatively be notified of information through a vibration or light. Also, the driver may be notified of information by combining two or more of a sound, a display, a vibration, and light. Furthermore, different combinations may be employed, or different modes of notification may be employed, in accordance with the level (e.g. urgency) of information of which the driver is to be notified. An input device 93 is a switch group that is arranged at a position at which the driver can operate the input device 93 and that is used to give instructions to the vehicle 1, and may also include a sound input device.

The ECU 29 controls brake devices 10 and a parking brake (not shown). The brake devices 10, which are, for example, disc brake devices, are provided for respective wheels of the vehicle 1, and decelerate or stop the vehicle 1 by applying resistance to the rotation of the wheels. For example, the ECU 29 controls operations of the brake devices 10 in accordance with a driving operation (braking operation) performed by the driver that is detected by an operation detection sensor 7b, which is provided in a brake pedal 7B. If the driving state of the vehicle 1 is automated driving, the ECU 29 automatically controls the brake devices 10 in accordance with instructions from the ECU 20 to control deceleration and stoppage of the vehicle 1. The brake devices 10 and the parking brake can also operate to maintain a stopped state of the vehicle 1. If the transmission of the power plant 6 has a parking lock mechanism, this mechanism can also operate to maintain a stopped state of the vehicle 1.

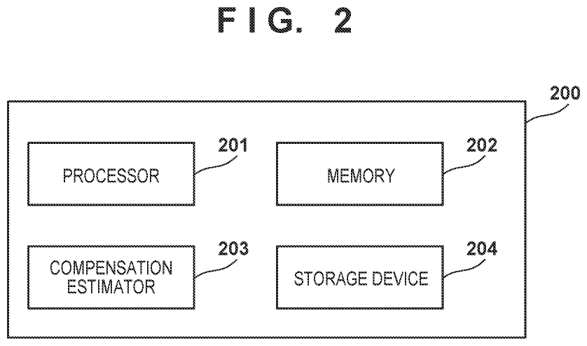

Next, a description will be given, with reference to FIG. 2, of a configuration of a device 200 for generating a policy for calculating a route in automated driving. A policy refers to a model (function) for calculating a path along which the vehicle 1 is to travel for a predetermined surrounding situation of the vehicle 1.

A path along which the vehicle 1 is to travel refers to, for example, a path along which the vehicle 1 to travel in a short period (e.g. 5 seconds) for the vehicle 1 to travel toward a destination. This path is specified by determining the position of the vehicle 1 every predetermined time (e.g. every 0.1 second). If, for example, a path for 5 seconds is specified every 0.1 second, the positions of the vehicle 1 at 50 points in time from 0.1 second later to 5.0 seconds later are determined, and a path obtained by connecting these 50 points is determined as the path along which the vehicle 1 is to travel. The “short period” here means a very short period compared with the entire travel of the vehicle 1, and is determined based on, for example, the range in which the detection units can detect the surrounding environment, the time required to brake the vehicle 1, or the like. The “predetermined time” is set to a short period in which the vehicle 1 can adapt to a change in the surrounding environment. The ECU 20 gives instructions to the ECUs 21, 26, and 29 in accordance with the thus-specified path to control the steering and acceleration/deceleration of the vehicle 1.

The device 200 includes a processor 201, a memory 202, a compensation estimator 203, and a storage device 204. The processor 201 is, for example, a general-purpose circuit, such as a CPU, and governs processing performed in the entire device 200. The memory 202 is constituted by a combination of a ROM and a RAM, and programs and data that are required for operations of the device 200 are read out from the storage device 204 and are executed.

The compensation estimator 203 is a device that is used to perform deep learning. The compensation estimator 203 may be constituted by a general-purpose circuit such as a CPU, or may be constituted by a dedicated circuit such as an ASIC or an FPGA. The storage device 204 stores data used in processing in the device 200, and is constituted by a HDD or an SSD, for example. The storage device 204 may be included in the device 200, or may be configured as a device separate from the device 200. For example, the storage device 204 may be a database server that is connected to the device 200 via a network.

For example, the storage device 204 stores reference actions that are based on an actual travel data on predetermined drivers. The predetermined drivers may include at least any of a driver who has had no accident, a taxi driver, and a certified skilled driver, for example. The driver who has had no accident refers to a driver who has had no accident for a predetermined period (e.g. 5 years). The taxi driver refers to a driver who drives a taxi as a profession. The certified skilled driver refers to a driver who has been certified as a good driver by a government or a company. In the following description, a skilled driver is dealt with as the predetermined driver.

The reference actions refer to a combination of surrounding situations, i.e. situations around the vehicle, and actions that a skilled driver has actually taken in those surrounding situations. The surrounding situations include the speed of a self-vehicle, the position of the self-vehicle in a traffic lane, the positions of other objects (other vehicles and pedestrians) relative to the self-vehicle, and the like, for example. The actions include, for example, a change in the amount by which the accelerator of the vehicle is operated, a change in the amount by which a brake is operated, a change in the amount by which the steering wheel is operated, and an operation of the direction indicators. The storage device 204 stores, for example, about 500 thousand sets of the reference action. As for the actions, the amount of each operation may be expressed by a single value, or the amount of each operation may be expressed as a probability distribution with values thereof. This probability distribution is a distribution in which an action with a higher probability that a skilled driver may take in a situation in which the vehicle 1 is placed has a higher value, and in which an action with a lower probability that a skilled driver may take has a lower value. Also, a configuration may be employed in which travel data is collected from a large number of vehicles, travel data that satisfies predetermined criteria, such as that abrupt starting, abrupt braking, or abrupt steering is not performed, or that the traveling speed is stable, is extracted from the collected travel data, and the extracted travel data is dealt with as travel data on a skilled driver.

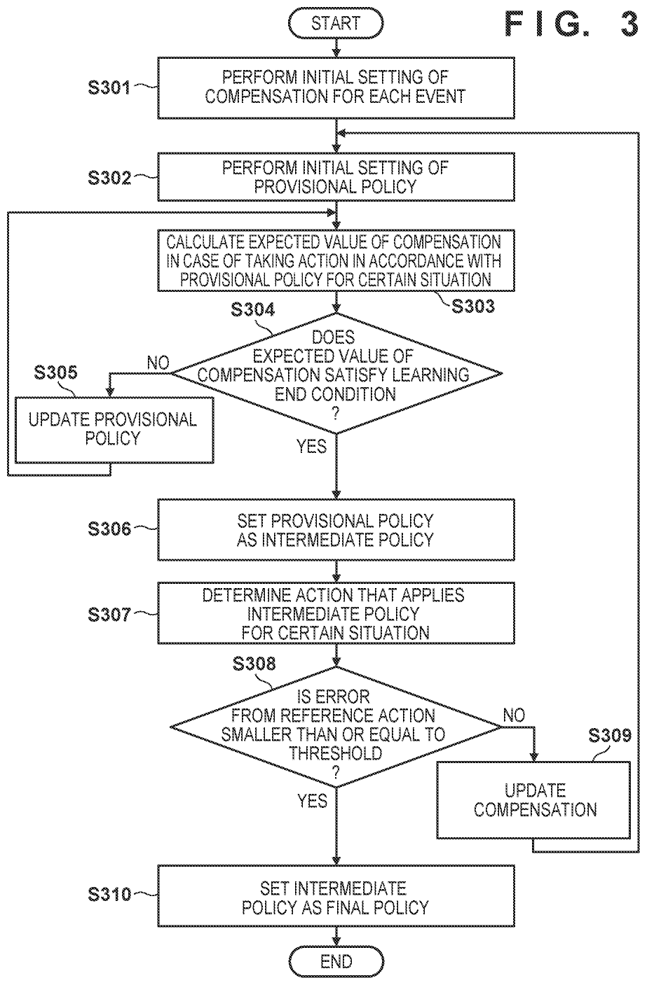

Next, a method for generating a policy for calculating a route in automated driving will be described with reference to FIG. 3. This method is performed by the processor 201 of the device 200. In the following method, a policy is generated through inverse reinforcement learning.

In step S301, the processor 201 configures an initial setting of compensation for each event. Events to which compensation is assigned include events to which positive compensation is given and events to which negative compensation is given. Events to which positive compensation is given include the case where the vehicle arrived at a destination in limited time. Events to which negative compensation is given may include the case where the vehicle collided other vehicles, the case where the vehicle continues to stop although the vehicle can proceed, the case where the vehicle traveled at high speed at a very close distance to a pedestrian, and the case where the vehicle accelerated or decelerated abruptly, for example.

In step S302, the processor 201 configures an initial setting of a provisional policy. The provisional policy refers to a provisional policy that is updated as needed through subsequent processing. For example, the initial setting of the provisional policy may be configured by randomly setting a parameter of the model.

In step S303, the processor 201 calculates an expected value of the compensation in the case of taking an action in accordance with the provisional policy with respect to a predetermined surrounding situation, by performing machine learning using the compensation estimator 203. First, the processor 201 randomly determines one initial surrounding situation in which the vehicle is placed. The processor 201 then determines an action that the vehicle is to take for this surrounding situation in accordance with the provisional policy. Then, the processor 201 simulates a change in the surrounding situation in the case where the vehicle takes this action. The processor 201 repeats this processing until a certain period (e.g. 1 hour) elapses or until an event for which compensation has been set occurs, and calculates an expected value of the compensation for an event that has occurred during travel. Specifically, the processor 201 calculates an expected value of compensation that is obtained by inputting the situation surrounding the vehicle and an action of the vehicle to the compensation estimator 203.

In step S304, the processor 201 determines whether or not the calculated expected value of compensation satisfies a learning end condition. The processor 201 advances the processing to step S306 if the condition is satisfied (“YES” in step S304), and advances the processing to step S305 if the condition is not satisfied (“NO” in step S304). For example, the processor 201 determines that the learning end condition is satisfied if the expected value of compensation calculated during a plurality of times of trial exceeds a threshold.

In step S305, the processor 201 updates the provisional policy and returns the processing to step S303. For example, the processor 201 updates the provisional policy such that the expected value of compensation increases.

In step S306, the processor 201 sets the provisional policy obtained through steps S302 to S305 as an intermediate policy. The intermediate policy refers to a policy obtained through reinforcement learning in steps S302 to S305.

In step S307, the processor 201 determines an action that is to be taken by the vehicle for a certain situation in accordance with the intermediate policy. This situation is selected from situations included in reference actions of a skilled driver that are stored in the storage device 204. In this step, actions may be determined for a plurality of situations.

In step S308, the processor 201 compares the action determined in step S307 with the reference action in the same situation, and determines whether or not an error therebetween is smaller than or equal to a threshold. The processor 201 advances the processing to step S310 if the error is smaller than or equal to the threshold (“YES” in step S308), and advances the processing to step S309 if the error is greater than the threshold (“NO” in step S308). For example, as for the amount of accelerator operation, it may be determined that the error is smaller than or equal to the threshold if the difference between the action determined in step S307 and the reference action in the same situation is 1% or less of the amount of reference action.

In step S309, the processor 201 updates the compensation for the individual event. For example, the processor 201 updates the compensation such that the error from the aforementioned reference action decreases. The processor 201 then returns the processing to step S302, and again determines an intermediate policy.

In step S310, the processor 201 sets the intermediate policy obtained through steps S301 to S309 as a final policy. The final policy refers to a policy that is to be stored in the ECU 20 of the vehicle 1 and is used in automated driving.

This final policy is stored in the memory 20b of the ECU 20. The processor 20a of the ECU 20 determines a path by applying the final policy to the situation surrounding the vehicle 1, and controls traveling of the vehicle 1 in accordance with this path.

### SUMMARY OF EMBODIMENT

### Configuration 1

A device (200) for generating a policy for determining a path in automated driving of a vehicle (1), comprising:

a compensation estimator (203); and

a processing unit (201) for generating a policy so as to increase an expected value of compensation obtained by inputting a situation surrounding a vehicle and an action of the vehicle to the compensation estimator,

wherein the compensation is updated based on an actual action taken by a predetermined driver, and

the action of the vehicle input to the compensation estimator is updated based on the policy.

According to this configuration, a policy for simulating an action of a driver can be generated.

### Configuration 2

The device according to configuration 1, wherein

the processing unit updates the compensation based on a result of comparing an action determined based on the policy with the actual action of the predetermined driver.

According to this configuration, a policy for simulating traveling performed by a human driver can be generated.

### Configuration 3

The device according to configuration 1 or 2, wherein

the predetermined driver includes at least one of a driver who has had no accident, a taxi driver, and a certified skilled driver.

According to this configuration, a policy for simulating an action of a highly skilled driver can be generated.

### Configuration 4

A vehicle (1) for performing automated driving, comprising:

a storage unit (20b) for storing a policy generated by the device (200) according to any one of configurations 1 to 3; and

a control unit (20a) for determining a path by applying the policy to a situation surrounding the vehicle, and for controlling travel of the vehicle in accordance with the path.

According to this configuration, automated driving conforming to a policy for simulating an action of a driver is enabled.

The present invention is not limited to the above embodiment, and various changes and modifications can be made within the spirit and scope of the present invention. Therefore, to apprise the public of the scope of the present invention, the following claims are made.

1. A device for generating a policy for determining a path in automated driving of a vehicle, comprising:
a compensation estimator; and
a processing unit configured to generate a policy so as to increase an expected value of compensation obtained by inputting a situation surrounding a vehicle and an action of the vehicle to the compensation estimator,
wherein the processing unit is configured to:
generate an intermediate policy through reinforcement learning, the reinforcement learning including: determining an action that a vehicle is to take by applying a provisional policy to a surrounding situation; obtaining an expected value of compensation by inputting the surrounding situation and the action to the compensation estimator; and updating the provisional policy until the expected value of compensation exceeds a predetermined threshold;
determine an action that a vehicle is to take by applying the intermediate policy to an actual surrounding situation of a predetermined driver;
determine whether an error between the action determined by applying the intermediate policy and an actual action by the predetermined driver is smaller than or equal to a threshold;
if the error is larger than the threshold, update compensation of the compensation estimator and determine again the intermediate policy with the compensation estimator having the updated compensation; and
if the error is smaller or equal to the threshold, set the intermediate policy as the policy.

2. The device according to claim 1, wherein
the predetermined driver includes at least one of a driver who has had no accident, a taxi driver, and a certified skilled driver.

3. A vehicle for performing automated driving, comprising:
a storage unit configured to store a policy generated by the device according to claim 1; and
a control unit configured to determine a path by applying the policy to a situation surrounding the vehicle, and for controlling travel of the vehicle in accordance with the path.
